(19) United States
(12) Patent Application Publication
(10) Pub. No.: US 2003/0086426 A1
(43) Pub. Date: May 8, 2003

(54) Computer based verification system for telecommunication devices and method of operating the same

(76) Inventors: Ivo Vandeweerd, Hasselt (BE); Steven Coenen, Borgloon (BE)

Correspondence Address: Gordon & Jacobson, P.C., 65 Woods End Road, Stamford, CT, 06905, US

(21) Appl. No.: 10/116,898

(22) Filed: Apr. 5, 2002

(30) Foreign Application Priority Data
Nov. 8, 2001 (WO) PCT/BE01/00193

(51) Int. Cl. H04L 12/28; H04J 3/16

(52) U.S. Cl. 370/394; 370/472

(57) ABSTRACT

A computer apparatus is described for displaying and manipulating sequences of frames of hierarchically organized framed data. The apparatus comprises means for generating a graphical user interface on a display screen, the graphical user interface having means for displaying a representation of a hierarchy of the framed data. The computer apparatus also has a pointing device for selecting a portion of the representation of the hierarchy to generate a control signal, and means responsive to the control signal to display a portion of the framed data corresponding to the selected portion of the representation of the hierarchy.

The graphical user interface may be used in a computer based verification system for the analysis and display of a sequence of frames of framed data, comprising:

means for generating a frame generator for receiving the frame sequence, the frame generator comprising means for processing the frame sequence in accordance with a protocol to form a modified frame sequence and for associating with each frame a description data structure for that frame, and

means for outputting the modified frame sequence and the frame description data structure.

The present invention relates to a verification system, in particularly a test bench system and method for verifying telecommunication system component and component design conformance with protocols and well as a usr graphics interface to be able to view traffic data manipulated by the verification/test bench system or method.

### TECHNICAL BACKGROUND

Computer and telecommunications technology has created a huge potential for integration. The design community has tackled a variety of subjects that try to make the maximum use of this potential by mastering this increased complexity. A crucial component in these efforts, is the challenge to overcome the verification complexity. Verification of telecommunications and computer based systems and components to be used in these systems is still a most time consuming and critical aspect of system design. Generally, all such systems and components operate in accordance with a certain protocol. A protocol is a set of rules which relates events of the past and/or present to those of the future, i.e. it defines action/reaction or stimulus/response behavior of the system. Complex telecommunications systems, such as a mobile telephone network or a Wide Area Network such as the Internet involve many individual components and/or complex protocols. All these network elements must conform to every aspect of the specified protocols. Generally, there are two major problems: a) to confirm that a specific design of a component conforms to the protocols, and b) a specific piece of equipment conforms to the protocols. Problem a) is often solved by simulation and b) by means of test benches. However, both solutions share a problem that any comprehensive test must include not only challenges with correct data but also ones with erroneous data, i.e. response behavior to both correct and erroneous stimuli must be checked. When an error is found, the designer is faced with a laborious process of finding out where the problem lies. This generally involves sifting through the recorded behavior of the object under test. The problems with test benches may be summarized as:

Testbench creation is at least as complicated as the actual design of a component, most of the time more complicated. A testbench has to be able to create all possible kinds of correct traffic but also a whole variety of incorrect traffic. The incorrect traffic is used to see if the design reacts and reports this incorrect traffic correctly.

Testbenches are duplicated over and over again for different projects. Most testbenches are too project specific so that they cannot easily be reused in a new project.

Testbenches that are written by the same team that designs a component such as a chip, lack a cross-check with an external source. A misinterpretation of the specification may go unnoticed.

One object of the present invention is to provide a verification or test bench environment and method of operating the same which allows rapid testing of designs and equipment.

Another object of the present invention to provide a verification or test bench environment and method of operating the same which allows easy visualization of the results.

### SUMMARY OF THE INVENTION

In one aspect, the present invention provides a design verification environment, e.g. a test bench environment, which combines a multi-project platform approach with a modular, extendible and high-level description capability required for telecommunication designs and devices such as complete systems-on-chip.

The present invention provides a computer apparatus for displaying and manipulating sequences of frames of hierarchically organized framed data, comprising:

means for generating a graphical user interface on a display screen, the graphical user interface having means for displaying a representation of a hierarchy of the framed data,

a pointing device for selecting a portion of the representation of the hierarchy to generate a control signal, and

means responsive to the control signal to display a portion of the framed data corresponding to the selected portion of the representation of the hierarchy.

The present invention may also provide a computer based verification system for the analysis and display of a sequence of frames of framed data, comprising:

means for generating a frame generator for receiving the frame sequence, the frame generator comprising means for processing the frame sequence in accordance with a protocol to form a modified frame sequence and for associating with each frame a description data structure for that frame, and

means for outputting the modified frame sequence and the frame description data structure.

The present invention may also provide a method of analyzing and displaying a sequence of frames of framed data, comprising the steps of:

generating a frame sequence in accordance with a protocol,

associating with each frame a description data for that frame, and

outputting the frame and the frame description data.

The present invention also comprises a method of analyzing framed data comprising the steps of: entering a descriptor file at a near location such as a terminal connected to a telecommunications network, the descriptor file comprising at least a representation of the operation of a telecommunications device;

transmitting the descriptor file over the telecommunications network to a remote location;

generating framed data at the remote location using a computer based system in accordance with any of the methods of the present invention;

and receiving at a near location the modified framed data and description data associated with the frame data.

The present invention also includes computer program products for executing any of the methods of the present invention when executed on a computer.

The present invention will now be described with reference to the following drawings.

### BRIEF DESCRIPTION OF THE DRAWINGS

FIGS. 1a and 1b are schematic representations of a verification system in accordance with embodiments of the present invention. FIG. 1a shows a standalone embodiment and FIG. 1b shows a co-simulation embodiment.

FIG. 2 is a schematic representation of a generator for use with the present invention.

FIG. 3 is a schematic representation of an analyzer for use with the present invention.

FIG. 4 shows the relationship between a common interface, a generator and an analyzer interface.

FIG. 5 is a schematic representation of a block communication means for use with the present invention.

FIG. 6 is a schematic representation of how blocks can be connected by a block communication means in the present invention.

FIGS. 7a and 7b show how more than one block may be connected to a generator and an analyzer respectively.

FIGS. 8a and b show linked generators and linked analyzers, respectively, in accordance with an embodiment of the present invention.

FIG. 9 shows a generator tree as used with the present invention.

FIG. 10 shows a generator scheduling as used with the present invention.

FIG. 11 shows an analyzer tree as used with the present invention.

FIG. 12 shows an analyzer scheduling as used with the present invention.

FIG. 13 is an overview of a standalone verification scheme in accordance with an embodiment of the present invention.

FIG. 14 is an overview of a co-simulation verification scheme in accordance with an embodiment of the present invention.

FIG. 15 shows a scheduling cycle for a standalone verification system in accordance with an embodiment of the present invention.

FIG. 16 shows a scheduling cycle for a co-simulation verification system in accordance with an embodiment of the present invention.

FIG. 17 shows the generation of descriptor data for frames during data stream generation in accordance with an embodiment of the present invention.

FIG. 18 shows the generation of descriptor data for frames during data stream analysis in accordance with an embodiment of the present invention.

FIG. 19 shows a screen shot of the display of a user graphics interface in accordance with an embodiment of the present invention.

FIG. 20a shows a screen shot of the data displayed in FIG. 19 for a different layer of the hierarchy.

FIG. 20b shows a detailed screen shot of the display of a user graphics interface in accordance with an embodiment of the present invention.

FIG. 21 shows a schematic representation of a computer with which the present invention may be used.

FIG. 22 shows a tagging scheme in accordance with the present invention.

### ACRONYMS

ATM Asynchronous Transfer Mode

DUT Design Under Test

HDL Hardware Description Language

PHY Physical layer

UTOPIA Universal Test & Operations

PHY Interface for ATM

VCI Virtual Component Interface

VHDL VHSIC Hardware Description Language

VHSIC Very High Speed Integrated Circuit

### DETAILED DESCRIPTION OF THE PRESENT INVENTION

The present invention will be described with reference to certain embodiments and drawings but the present invention is not limited thereto but only by the attached claims. For example, the present invention will mainly be described with reference to the computer language C++ but other languages may be used, e.g. ADA.

The present invention provides a computer-based design verification system, in particular a test bench system for generating and analyzing telecommunication data traffic, especially as related to a design of a telecommunications device or a component thereof. The verification or test bench system may be implemented in hardware but in a preferred embodiment the verification or test bench system is implemented in software, e.g. computer program products written in a suitable computer program language such as C++ and their execution on a computing device. The computer program product when run on a suitable computing device generates and analyzes telecommunication data traffic. The verification or test bench system may find advantageous use as a reference system or test bench to verify the functional correctness of designs or components of telecommunications systems such as complete devices or designs of components used in such devices.

The verification or test bench system comprises a frame generator and an analyzer, preferably implemented as a multi-protocol test bench for traffic data simulation at the system level. It is not anticipated that the nature of the telecommunications protocol will be a limitation on the present invention, e.g. suitable protocols are PDH, SDH, SONET, ATM, HDLC, PPP, IP. The verification or test bench system also includes a graphical user interface for viewing and manipulating the data which has been generated and/or analyzed. Optionally, the present invention also includes verification and analysis of physical devices using the verification system.

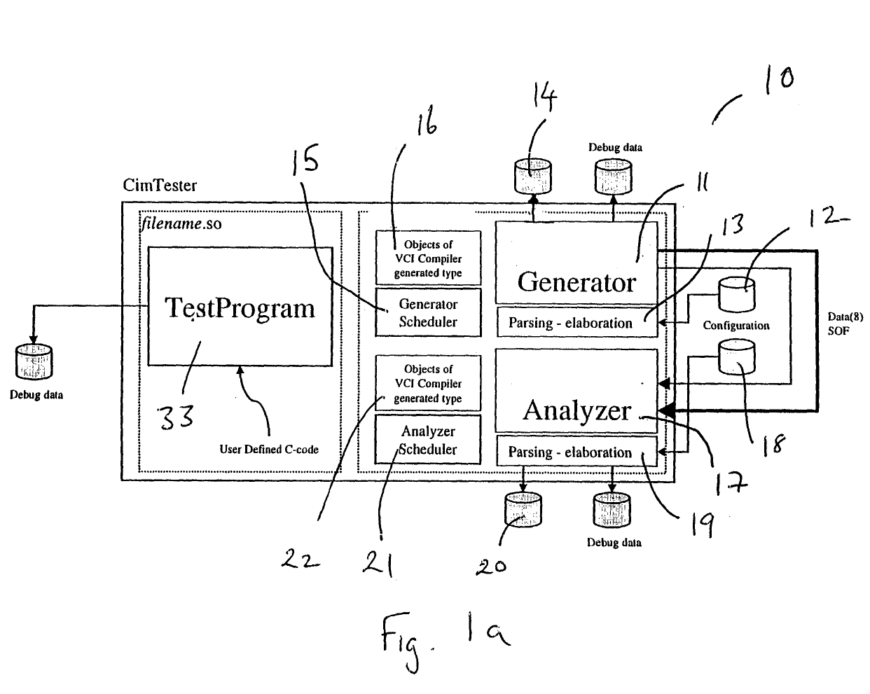

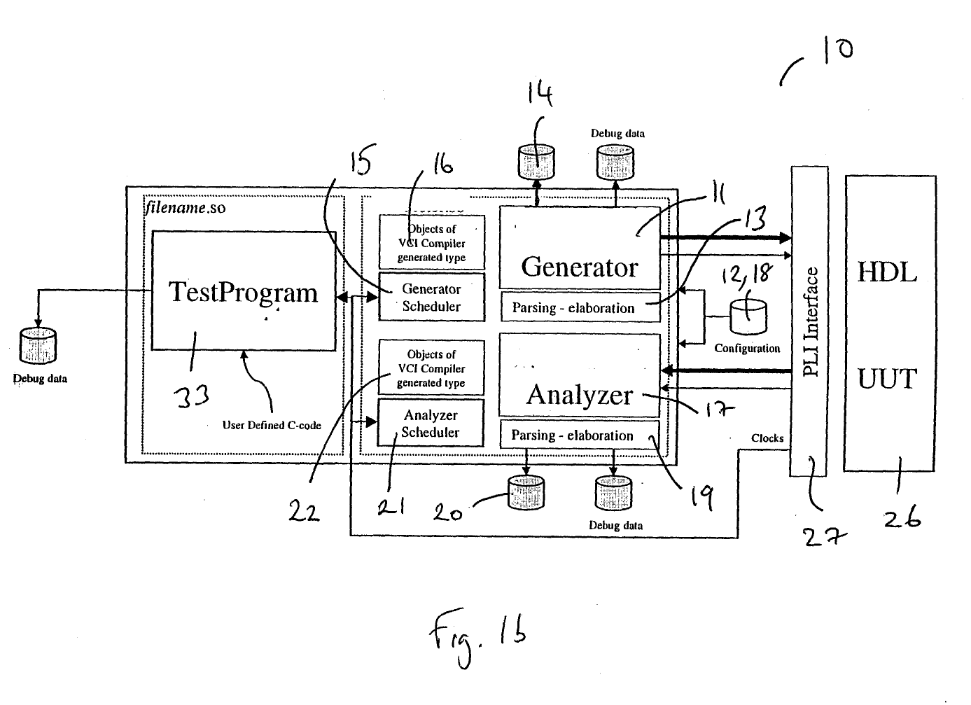

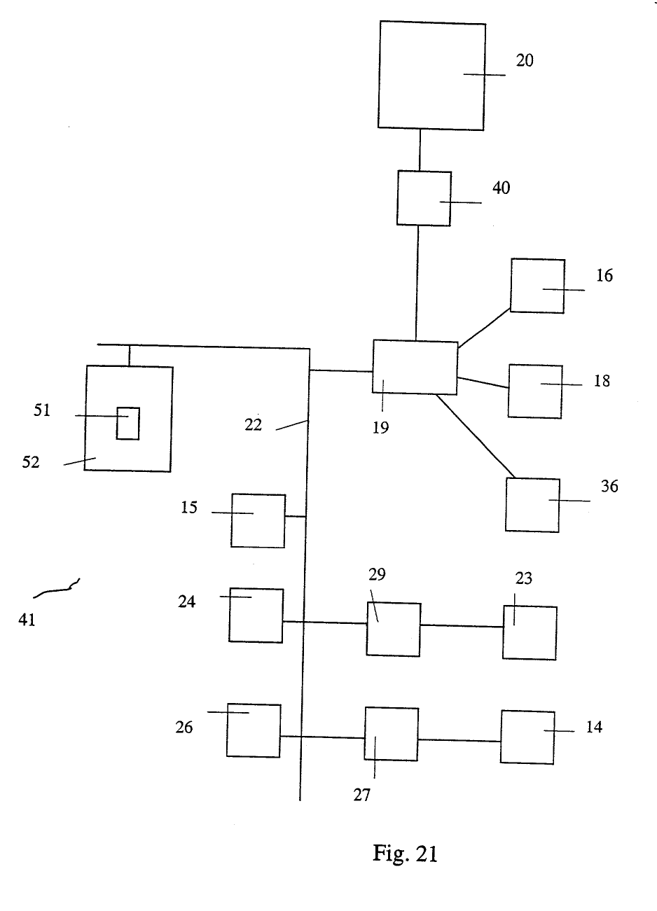

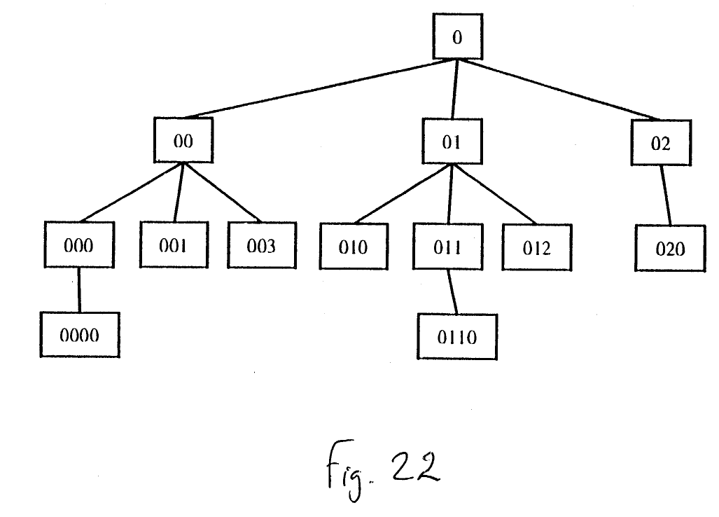

The verification system can be operated as a standalone system 10 and is shown schematically in FIG. 1a. The system 10 is for use on a general purpose computer and the verification system is implemented as a computer program running on the computer, e.g. as shown in FIG. 21. The main elements of the system are:

1. One or more data generators 11 for generating a stream of digital data in accordance with one or more protocols. The structure and function of these generators is determined by a configuration file 12 which is a descriptor file which may be read by the computer program running on the computer, parsed by a parsing element 13 and the generators configured along with their communication links on instantiation of the system. For instance, the configuration file may be in XML format. The data stream generated is associated with descriptor data for the stream which will be described later. This descriptor data can be dumped and stored in memory 14, e.g. on a hard disk, a CD-ROM, diskettes, tape, etc. To control the functioning of the generators 11, a generator scheduler 15 is provided. Optionally, an object generator 16 may be provided for generating objects such as ones of the VCI compiler type.

2. One or more data analyzers 17 for analyzing a stream of digital data in accordance with one or more protocols. The structure and function of these analyzers is determined by a configuration file 18 which is a descriptor file which may be read by the computer program running on the computer, parsed by a parsing element 19 and the analyzers configured on instantiation of the system along with their communication links. For instance, the configuration file may be in XML format. The data stream analyzed is associated with descriptor data for the stream which will be described later. This descriptor data can be dumped and stored in memory 20, e.g. on a hard disk, a CD-ROM, diskettes, tape, etc. To control the functioning of the analyzers 16, a generator scheduler 21 is provided. Optionally, an object generator 22 may be provided for generating objects such as ones of the VCI compiler type.

3. A test program 23 which can be generated by a user and which determines the tests to be carried out. The test program is read by the verification system and executed.

4. Optionally, to provide communications with a design to be tested, address locations for registers in the design to be tested may be generated automatically, e.g. by VCI compilers 16 and 22 for the generators and analyzers respectively.

A verification system can also be operated as a co-simulation system 10 and is shown schematically in FIG. 1b. Items with the same reference numbers as in FIG. 1a refer to the same items. The main difference is that a simulation 26 of the design to be verified is also run on the computer and communicates with generators and analyzers via a suitable interface, e.g. a PLI interface, 27, implemented as a computer program or routine running on the computer.

Further, actual physical devices can be verified by using the verification system 10 of FIG. 1a. Firstly, the standalone system 10 is run using a simulation of the device to be checked to generate a data stream as well as data descriptor files stored in memories 14 and 20. The generated data stream is then supplied to the device to be tested. The output of the device is recorded on a suitable medium or delivered directly to the verification system 10. This device output is input into the system 10, namely to the analyzers. These analyze the data based the data file in memory 20 from which a frame organization can be derived. Errors can then be determined and examined, e.g. by displaying the traffic data frames using a user graphics interface preferably in accordance with the present invention (described later).

Provided the computer system can deal with the realtime restraints of a physical device, the output of a real device may be connected directly to the computer, e.g. via a suitable interface and if required via a buffer in case rate matching between the computer and the device are required. In this case the data stream output of the generators 11 can be fed to the device through a suitable interface and its response delivered to the analyzer section of the verification system again through an interface. The frame data descriptor file generated by the generators is provided to the analyzers so that they demultiplex the received data and allow visualization thereof.

Typically, telecommunications systems use data in frames, whereby the frames are organized into a hierarchy, e.g. of frames, super frames, etc. In embodiments of the present invention a collection of traffic data generators and analyzers are provided that can be linked together to create or analyze a specific data stream, respectively. A block may be either a generator or an analyzer. Each type of block implements a communications protocol or a part of such a protocol. By connecting different instances of various types of blocks, a more complicated hierarchy of protocols, or one big protocol with different levels can be created. How to connect all the blocks is specified in a configuration file as described above. Both generator side and analyzer side each have a configuration file. Multiple, possibly different, trees of hierarchy can be created in one configuration file. This can be useful if the hardware design supports multiple protocols.

A computer based verification or test bench system in accordance with the present invention stores a parseable description of how different protocol layers can be structured and preferably includes validation means to check if a configuration file is in violation with one of the structuring rules and to throw an error message if this is the case. Preferably, the verification or test bench system includes means to provide a suggestion on how to make the structuring valid.

Each block in a verification or test bench system according to the present invention has control variables that can alter the behavior of a block or even change the protocol generated or analyzed by that block. Inserting protocol errors is an example of a change in behavior. Each block also has means for giving information about the current state of the block. An error counter is a typical example of such a means. To set and read all these control variables and status registers, a user can create a test plan function written in a suitable computer program language such as C++. This test plan function has to be compiled into a shared object file. The test bench system loads this shared object file and executes the compiled test plan function when the simulation starts. In the test plan function, the user can use wait statements to pause the execution of the test plan function for a number of cycles or until a certain event occurs. A verification or test bench system according to the present invention puts no restrictions on the test plan function, i.e. the user can write any code desired. User customization can include creation of a customized graphical interface, reading in and parsing a command file for stimulating some control signals, integration of third party libraries.

Not only the blocks of a verification or test bench system according to the present invention have control and status registers, a device design under test (DUT) with the test bench according to the present invention may also have several control and status registers. The present invention includes a method for hardware/software cosimulation, i.e. the ability to access control and status registers from a computer program. This computer program can generate a test bench to test the DUT on execution on a computing device or can contain the code that will run on an embedded processor. This way of accessing registers in the DUT can also be used. The present invention includes reactive test plans. For example, the user can insert an error in a generator using a control signal from that generator and then check that the DUT has processed that error correctly by monitoring the status registers of the DUT.

Sometimes a device design to be tested has its own proprietary protocol for internal use. A test bench system in accordance with the present invention may optionally be extended with user defined protocols in the form of an external block. Such an external block is treated the same way as a built-in block. All the default capabilities of a built-in block are made available to an external block.

A verification or test bench system in accordance with an embodiment of the present invention may comprise three main parts:

Part 1 sets up the complete running environment. It preferably includes means for reading configuration files, means for validating them, means for creating all blocks and means for interconnecting all the blocks. In design cosimulation with a simulator such as an HDL simulator, this part also includes means for setting up a connection to the simulator.

Part 2 is a scheduler. This part makes sure the correct block is executed at the correct time.

Part 3 comprises the blocks, the generators and the analyzers of the verification or test bench system. These items implement protocols.

The running environment setup part when executed on a computing device executes the same sequence of tasks every time the test bench system is started:

1. Parse command line arguments.

2. Parse a settings file if it exists

3. Read generator and analyzer configuration files

4. Validate the configuration file, i.e. check that the structuring of blocks in the configuration file is valid.

5. Create and connect generator blocks with their configurations

6. Create and connect analyzer blocks with their configurations

If the test bench system is running in cosimulation with a simulator such as an HDL simulator, this part also sets up the connection with the simulator. It also instructs the scheduler to use the connection with the simulator, that is to send generated data to, and read data to be analyzed from the simulator.

All the blocks in the verification or test bench system preferably have a common interface 30. For generators and analyzers, this common interface 30 has generator or analyzer specific properties, respectively.

The common interface 30 for all the blocks consists of properties that all blocks share in the verification or test bench system. The verification or test bench system operates with and on framed digital data. Among these common properties the following is a non-limiting list: byte, row, column and frame counters, size and shape of a frame in a protocol, an indication if the protocol is bit oriented or byte oriented, a method to reset a block. The use and implementation of these properties is protocol specific and therefore implemented differently for each protocol. Some properties are the same for many protocols. For those very common properties, a default implementation can be provided. For example, the shape of a frame of data in a protocol is often rectangular. The common interface can therefore provide functions to calculate the byte, row, column and frame counters for rectangular frames.

The interface 31 for a generator preferably comprises:

A list of input traffic streams to the generator. The size of the list can be 0 which means that the generator does not have an incoming data stream. The size of the list is not fixed, it depends on the protocol. For example, for a protocol that multiplexes 3 data streams into 1 data stream the size of the list would be 3.

One output of the generator. All the traffic that a generator generates will be presented on this output.

A function that runs the implementation of the protocol, i.e. generate traffic and put it on the output.

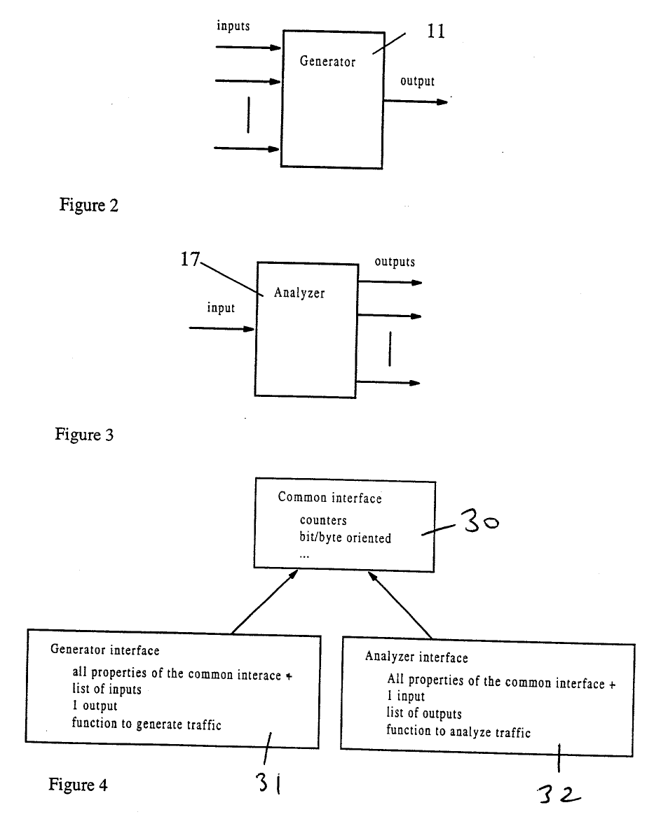

All generators share this generator interface 31. Each generator can add other protocol specific properties when needed. A schematic representation of a generator 11 is shown in FIG. 2.

The interface 32 for an analyzer preferably comprises:

One input of the analyzer. All the traffic that an analyzer analyzes will be available on this input.

A list of output traffic streams. The size of the list can be 0 which means the analyzer does not have an outgoing data stream.

A functions that runs the implementation of the protocol, i.e. analyze the traffic available on the input.

All analyzers share this analyzer interface 32. Each analyzer can add other protocol specific properties when needed. A schematic representation of an analyzer 17 is shown in FIG. 3.

The relationship between a common interface 30 and specific generator and analyzer interfaces 31, 32 can be seen in FIG. 4.

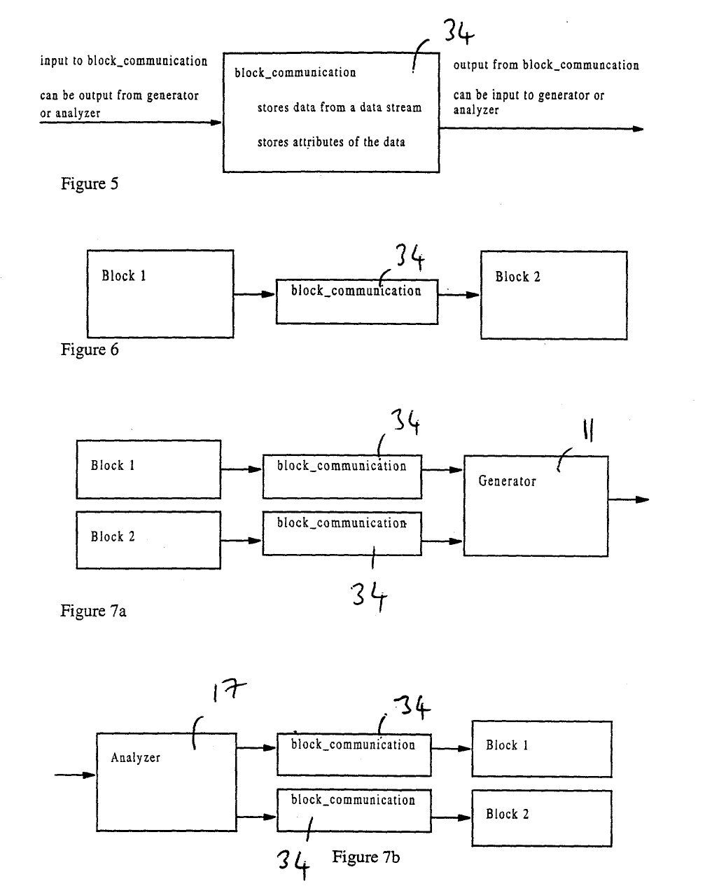

The inputs and outputs for both generator and analyzers also have the same interface and the same implementation. In a verification or test bench system in accordance with the present invention these inputs and outputs are called block communication means 34. Block communication means 34 provide means to put data onto or get data from a block. Also means are provided to check if there is still room to store data on a block or to see if there is data available. Besides that, the block communication means 34 also provide means and methods to annotate traffic data with attributes. On example of an attribute of data is e.g. whether or not this particular data is the start of a frame. A graphical view of the block communication means 34 is shown in FIG. 5.

To connect two blocks, one block communication means 34 has to be created. The output from the first block and the input of the second block have to be connected to the block communication means 34. Because all the inputs and outputs of all the blocks have the same standardized interface—i.e. block communication means 34—any block can be connected to any other block. FIG. 6 shows schematically how this is done.

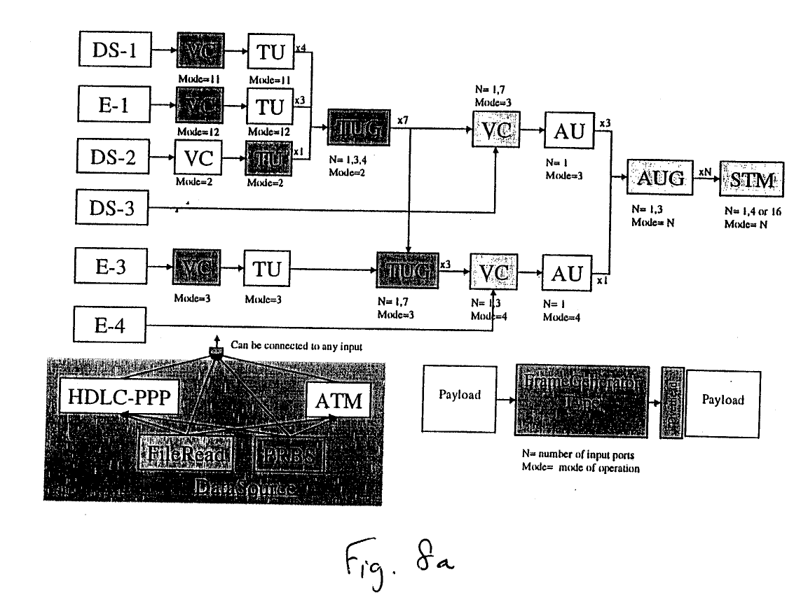

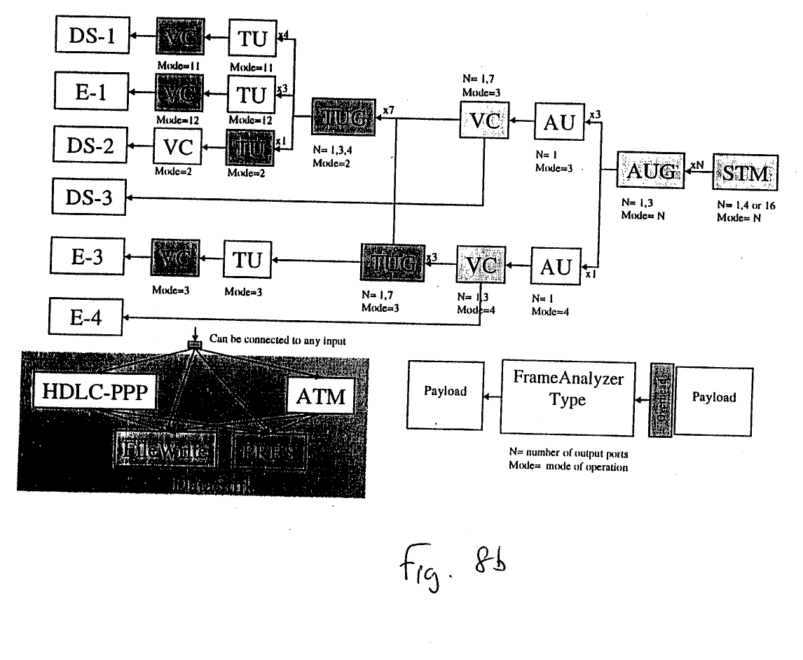

Generators can have multiple inputs. The input side of the generator can be connected to multiple other blocks. An example is shown in FIG. 7a.

Analyzers can have multiple outputs. The output side of an analyzer can be connected to multiple other blocks. An example is shown in FIG. 7b.

Mixing generators and analyzers can be provided in accordance with the present invention. Preferably, in a test bench system in accordance with the present invention traffic data is generated for a DUT and traffic from the DUT is analyzed.

A complete scheme for generators and for analyzers is shown in FIGS. 8a and 8b respectively. FIG. 8a shows a hierarchy of generator blocks which finally produce a stream of framed data from the final generator (a scheme for the SDH is shown by way of example). Each generator implements a part of the total protocol. The aim is to generate a data stream which conforms to the standard or which has been modified in a specific way so as to challenge a design under test. Effectively, the data generated by the generators is multiplexed together to form a single data stream. To provide some realistic data various data sources can be provided. Framed data usually consists of user data or “payload”, and administrative data called “overhead”. A suitable payload can be read (FileRead) for instance from a file in memory in which sample payload data is stored. Random data may also be generated in a random generator (PRBS). FIG. 8b shows a similar hierarchical structure for analyzers. In this case there is a single bit stream input and this is segmented to obtain the individual overhead and payload information, effectively by demultiplexing. Further data sinks are provided, e.g. the data generated may be stored in a file (FileWrite), data which should be random can be checked by a random number checker (PRBS).

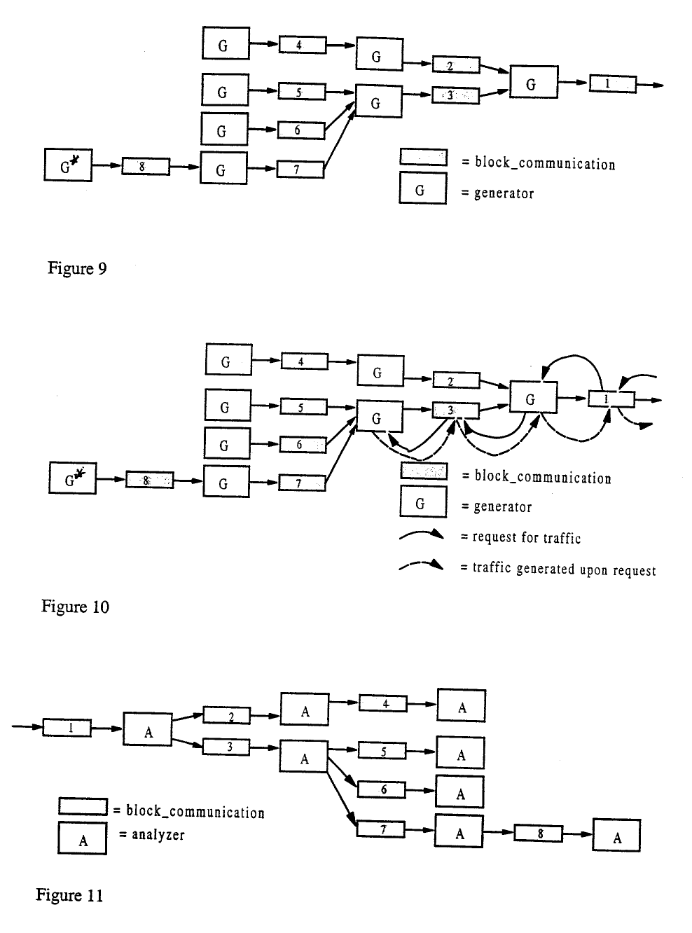

The scheduling for generators and analyzers is different. As shown above an interconnection of multiple generators is generally organized in a tree structure. There is 1 top level generator with 0, 1 or more generators connected to it. Each connected generator can have 0, 1 or more generators connected to it, just like the top level. The resulting structure a tree as shown schematically and in more detail in FIG. 9. The generation of traffic data is started whenever traffic is requested from a block communication means 1. Block communication means 1 knows from which block it should request traffic when it has to generate traffic itself. In this case this is the top level generator. It requests traffic from that generator by calling the function that generates traffic and puts that traffic on its output. The output of the generator is the same block communication means as the one that requested the traffic. So the block communication means requests traffic from the generator and the generator delivers that traffic to the block communication means. The generator itself may be able to generate the requested traffic by itself or may need traffic from another generator. Which option the generator has to take depends on the protocol. If the generator can generate the traffic by itself, the end of the scheduling cycle has been reached. The request for traffic on block communication means 1 has then been fulfilled. If the generator needs traffic from another, lower level, generator, the same algorithm is used. The generator requests traffic from block communication means 2 or 3, depending on the protocol. Suppose its from block communication means 3. Then block communication means request traffic from the generator that is connected to it (the left one) in the same way as the top level block communication means requested traffic from the top level generator. This scheduling can ripple to all the leaves of the tree, or it can stop somewhere in the middle. The leaves of the tree are special generators G*, they don't need traffic from another generator, they can generate all traffic by themselves, i.e. they are data sources. They may be referred to as Data Generators. FIG. 10 shows a scheduling for generators.

Note that, in accordance with embodiments of the present invention, generators don't have to generate traffic when they are not doing anything. This differs, for instance, from an HDL simulator where each logical block runs on a clock. On every event of that clock, a logical block is executed, even if there is no need to execute it. The HDL simulator has no way to schedule the block intelligently because it has no information on the block relating to how to schedule it. In accordance with the present invention the scheduler is configured as an “on-demand” scheduler, that is the scheduler does not activate blocks at each time step but only activates blocks when these have a function to carry out.

The block communication means 34 preferably also has some built-in intelligence. If a generator did not generate enough traffic for the request, a new request is sent to the generator to generate more traffic. This is done until the generator has generated enough traffic to fulfill the request. For example, if a generator implements a bit oriented protocol, the generator may generate 1 bit at a time. If the generator is connected to another generator that implements a byte (=8 bits) oriented protocol, meaning it always sends out request for bytes, the block communication means will make sure that a complete byte is always generated. It does this by requesting 1 bit from the bit oriented generator, 8 times in a row.

An interconnection of multiple analyzers is also in a tree structure. There is 1 top level analyzer with 0, 1 or more analyzers connected to it. Each connected analyzer can have 0, 1 or more analyzers connected to it, just like the top level. FIG. 11 shows an example.

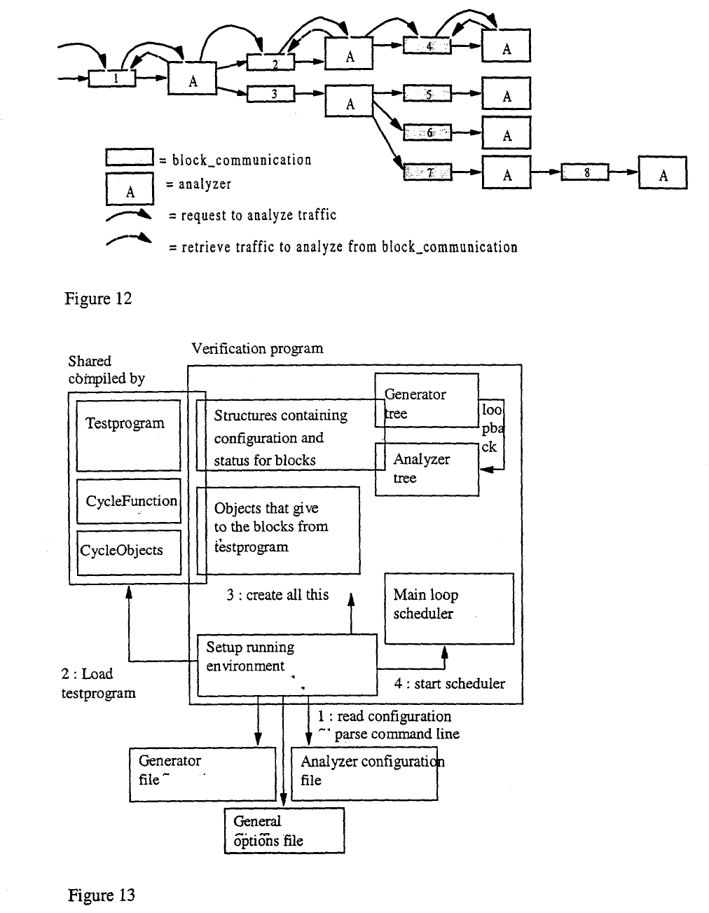

The scheduling algorithm is similar to that for a generator, but the request is different. For analyzers, the request is a request to analyze traffic. A block communication means has a certain traffic data and sends a request to the analyzer it is connected to, to analyze that traffic data. The analyzer retrieves the traffic data from the block communication means and analyzes it. The analyzer can either analyze the traffic itself, or it can pass the traffic to another analyzer requesting it to analyze the traffic. FIG. 12 shows how this is done.

Most of the time, the standard behavior of a block is not sufficient to test a DUT. The present invention allows a user to modify the behavior of a block to get a specific behavior of a block, i.e. the present invention includes means to modify the behavior of a block. The block may also have means to report some information to the user. All this information and configuration is grouped together in a structure. For each type of block (implementing a specific protocol) this structure is different. For two instances of the same type of block, there are also two instances for this structure. Both the user and the block can easily access these structures. These structures are important for the user. They give information about what a block in the verification or test bench system is capable of doing. Because of the importance of the structures, they are preferably well documented and easy to understand. In the verification or test bench system the structures for each type of block may be described in a ‘datamodel’ file. From that file, computer code is extracted which implements the structures. This way, developers can very easily write documentation for the block they are developing. The document that is extracted is called the ‘Control signals’ document.

Because the structures are generated separately, they are preferably kept separate from the blocks. When setting up the running environment, the test bench system creates the structures when needed and attaches them to the correct blocks. A reference to the structure is also stored for use in a test program.

The test program is the part the user has to write or standard test programs may be generated. It controls all the blocks in the test bench system. In the test program, the user can also control the DUT through an interface such as a VCI interface. The user can also write wait statements in the test program. This suspends the test program for a certain time, while the generators and analyzers keep on running. How long the test program is suspended depends on the type of wait statement used. There can be 3 types of wait statements, for instance:

WAIT_CYCLE suspends the test program for 1 cycle.

WAIT_CYCLES(n) suspends the test program for n cycles.

WAIT_UNTIL(condition) suspends the test program until the given condition becomes true.

The generator tree and the analyzer tree can become very large. It's also possible and very likely that there are many generator instances in the tree of the same type (implementing the same protocol). The present invention provides an easy way to uniquely identify each generator in the tree. A simple tagging scheme used for this identification:

The top level block in the tree gets tag ‘0’.

All the children of a block inherit the tag of their parent. For each child, ‘.n’ is added to the parent tag where n is the number of the child. FIG. 22 shows this tagging scheme. If the user wants to change some configuration of a block, the tag of the block has to be known. The verification or test bench system can provide a list of all the tags on request. Once the tag is known, the user can change the configuration with a line of code like:

VC_DataGenerator[“tag”].config.mode=CT_INCREMENTAL;

VC_DataGenerator is the name of the configuration for the data generator block. All the names of the configurations are documented in the ‘Control signals’ document. “tag” is the string representation of the tag associated with the block.

Some combinations of protocols require more communication than just passing traffic data. Sometimes the need arises to negotiate on what kind of traffic should be sent. To be able to implement such protocols in a verification or test bench system according to the present invention, a message protocol is provided to communicate between blocks. A block has means to send a message to another block that is attached to it. The block that receives this message, has to process it and send back a reply. If a message is not processed, the test bench system will give an error message.

When executed on a computing device the test program preferably has one thread of control. If the user has various events that occur at different times, managing these events in a single thread of control requires care.

In a verification or test bench system according to the present invention, the user can define a computer program function that has to be executed every cycle, the CycleFunction. It also has to finish in the same cycle, so wait statements are not allowed in this function. In this function, the user can check for events and report/store information for the main test program. Several events can be checked and reported/stored in this function.

Another option to check various events is to have multiple test programs running in parallel in a multi-threading environment.

This CycleFunction concept is further refined in CycleObjects. The user can attach an object to a block. Before the block will generate or analyze traffic data (after a request to do so), a specific function in this cycleobject is called. That function can check various things in the block or somewhere else and report/store information for the main test program or for some other CycleObject. Because this is an object (and not just a function), it can store some state inside itself. What is stored is totally up to the user. This can be useful when the user is e.g. counting events. The counter can be stored in the object. As with the CycleFunction, the function in the CycleObject cannot have wait statements.

The configuration and status of a block only contains variables that can be set and read. Correctly setting a complicated configuration can easily become very cumbersome. A higher level of configuring a block can be useful in this case. A higher level means not setting a plurality of variables in a consistent way, but calling a function that does the setting of the variables and keeps them consistent. The best place to put such a function in inside the block the user is configuring because that is also the block that will be using the settings. To be able to do this, the user has to be able to access all the blocks in the test bench system. Once access to the block is achieved, the user can call the functions as required. Accessing a block can use the same tagging scheme as for accessing the configuration structures. e.g.:

Block_ATMTrafficSplitterAnalyzer[“tag”].addRoute(3,5,1);

Block_ATMTrafficSplitterAnalyzer gives access to the correct block based on the tag.

addRoute is a function defined and documented in the ATMTrafficSplitterAanlyzer.

A verification or test bench system in accordance with the present invention can have two modes of operation.

a standalone mode, i.e. without a simulator attached to it. The traffic generated by the generator tree is fed into the analyzer tree.

cosimulation mode, i.e. with a simulator attached to it. The traffic generated by the generator trees is transferred to the simulator domain and is there applied to the DUT. Traffic coming from the DUT that is to be analyzed by the test bench system is transferred to the test bench system domain and fed into the appropriate analyzer tree.

The overall architecture in standalone mode is shown if schematically in FIG. 13. In this system the output of the generators is fed to the input of the analyzers. In step 1 the configuration files are read and parsed, in step 2 the test program is loaded including CycleFunction and CycleObjects, in step 3 the generators and analyzers are created as well as all the block communication means. At this point the verification system has been created. Traffic generation is initiated in step 4 by the main loop scheduler requesting traffic from the generator tree and requesting the analyzer tree to analyze that traffic. This is one cycle. This process is continued until a given cycle limit is reached.

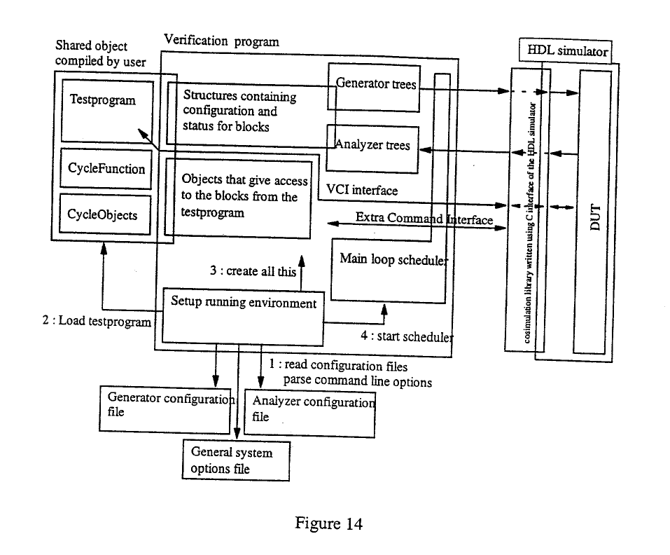

The overall architecture in cosimulation mode is shown schematically in FIG. 14. A DUT can support multiple protocols, so in cosimulation the present invention supports multiple generator and analyzer trees. Operation is similar to the standalone mode but the output from the generators is sent to the DUT via the simulator interface and received therefrom for the analyzers. Alos an ‘Extra Command Interface’ may be used when the test bench system domain needs some information from the simulator domain that is not directly related to the traffic being generated or analyzed. This interface is also used to do some settings in the test bench system cosimulation library. For example, the user can request the current simulation time in the test program without advancing time in the simulator using a get function.

The communication between the simulator and the test bench system program is preferably implemented using 2 unidirectional pipes per type of communication. There are 4 types of communication (generator traffic, analyzer traffic, VCI communication and ‘Extra Command Interface’ communication), so 8 unidirectional pipes are used. Both the test bench system and the cosimulation library monitor all pipes to see if there are requests coming on a pipe. If there is a request on a pipe, it is processed and all pipes are being monitored again.

Note that the test bench system and the simulator are in lock-step, i.e. when test bench system is running the simulator is paused. When the simulator is running, the test bench system is paused. This gives fully deterministic execution. Running the same simulation twice gives exactly the same results.

In cosimulation mode, it is the simulator that drives traffic generation and analysis. Each generator tree and analyzer tree is associated with a clock in the simulator. On every rising edge of such a clock, a request is sent to the appropriate generator or analyzer. For a generator, the test bench system will generate traffic and the cosimulation library will put that on the signals connected to the DUT. For an analyzer, the cosimulation library reads the traffic available on the signals coming from the DUT and transfers that traffic to the correct analyzer.

The test bench system presents/expects the traffic to follow a protocol. If the DUT does not have the exact same protocol, a small module that converts the protocols can be used. This converter module is called an adaptor.

A scheduling cycle is as follows:

1. A test program is executed until a WAIT_CYCLE is encountered. The other wait statements (WAIT_CYCLES(n) and WAIT_UNTIL(condition)) both use WAIT_CYCLE.

2. The WAIT_CYCLE activates the main loop scheduler.

3. The main loop scheduler is different in standalone mode and cosimulation mode

In the Standalone mode the CycleFunction is executed. The generator tree get's a request to generate traffic (1 byte of data). That traffic is given to the analyzer tree to analyze. The current cycle count is compared with the given cycle limit. If it is greater, the verification system terminates. If it is not greater, the main loop scheduler finishes and the testplan execution is resumed.

In cosimulation mode the scheduler watches the communication pipes with the simulator. There are 3 possible cases:

If a request comes for generator traffic (rising edge of a generator clock), the correct generator tree get's a request to generate traffic. That traffic is sent through the communication pipes to the simulator.

If a request comes to analyze traffic (rising edge of an analyzer clock), the traffic is retrieved from the simulator through the communication pipes. The correct analyzer tree is requested to analyze this traffic.

If there is a request for a VCI action, that request is processed. The CycleFunction is called before processing this VCI request.

When the first two cases finish, the main loop scheduler resumes watching the communication pipes. In the third case, the main loop scheduler finishes and the test plan execution is resumed.

4. Test plan execution is resumed until another WAIT_CYCLE is encountered. Scheduling continues with step 2. Note that a VCI command in the testprogram is also treated as a WAIT_CYCLE.

Before the generator or analyzer function is called that should generate or analyze traffic, all CycleObjects attached to that generator or analyzer are executed. This happens in both standalone and cosimulation mode.

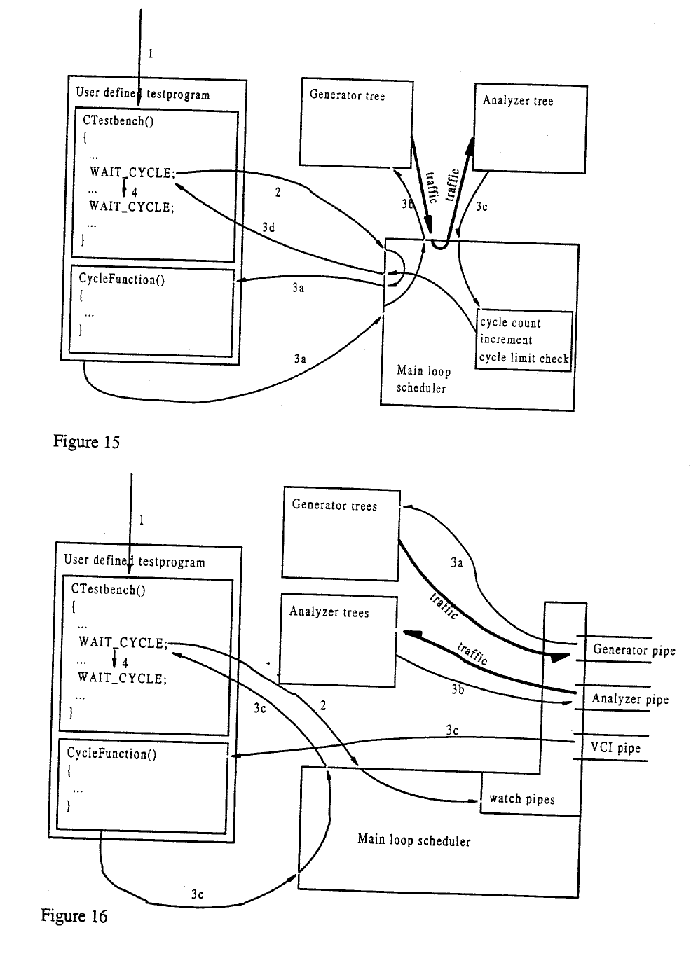

FIG. 15 shows the scheduling in standalone mode. FIG. 16 shows the scheduling in cosimulation mode.

An important aspect of the present invention is to be able to view framed traffic data in a convenient way. Hence, the present invention includes a user graphical interface to view framed data. It displays the frames generated and/or analyzed by the verification or test bench system, with a possibility to traverse through the hierarchy of frames.

The viewer has two parts. One part is inside the verification or test bench system as is used to prepare data in such a way as to make viewing more robust. It collects information on the traffic while it is being generated or analyzed and annotates it. The other part is a viewer application. The additional information associated with the traffic data added by the first, part is used by the viewer part to view the data and navigate through it. The viewer displays the information collected in the first part. In the test bench system, traffic data is divided into pieces, e.g. for ATM traffic, the verification or test bench system does not generate a complete cell at a time, but a single byte from a cell each time. Together with each piece of traffic, not only the value of the traffic (the value of the byte in the ATM cell) is stored, but also some extra parameters or descriptors of the data like start-of-cell indication, end-of-cell-indication. This piece of information travels through the whole hierarchy of blocks and block communication means.

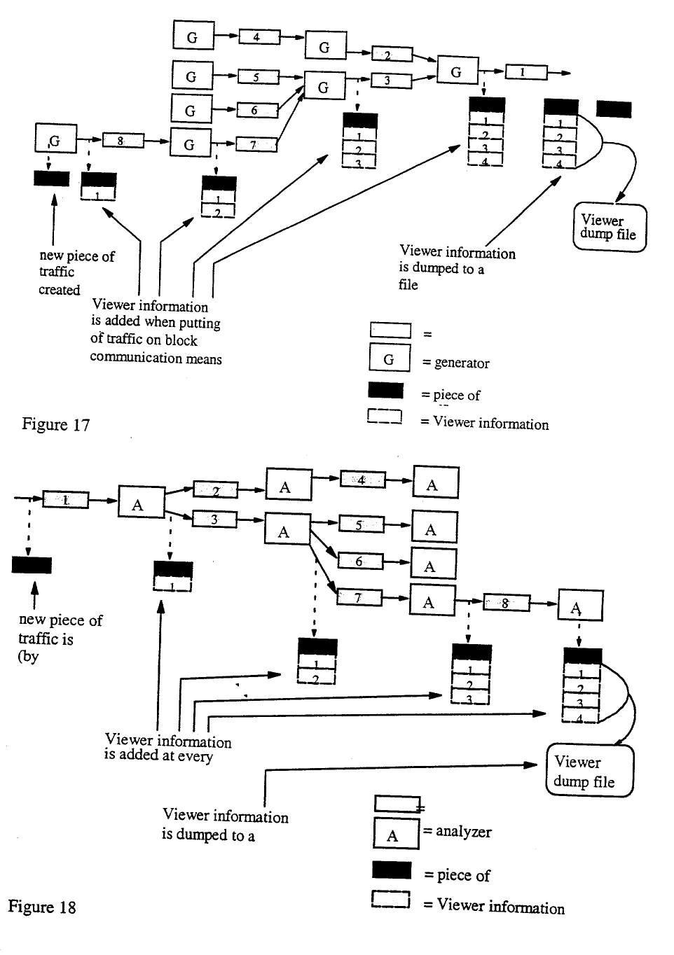

The viewer part inside the test bench system adds some more information. For each block a piece of traffic passes through, information about the current state of the block and the current state of the piece of traffic is added to the piece of traffic. As a piece of traffic travels through the hierarchy of blocks, all required viewer information is created. The descriptor information is preferably added at the block communication means. The file should be dumped before the data stream leaves the generators so that the additional information does not disturb the operation of the simulated device. FIG. 17 shows how viewer information is gathered in the generators. FIG. 18 shows the same thing for analyzers.

Information that can be added per level is:

value at the current level in the hierarchy (value can change due to scrambling, . . . )

The tag of the block

byte and frame counter (as provided by the common interface for all blocks)

payload, overhead, start-of-frame, end-of-frame, head-of-packet, tail-of-packet indications (also provided by the common interface for all blocks)

amount of traffic (number of bits)

scrambled/descrambled version of the piece of traffic is applicable

For analyzers, indication on how the piece of traffic was analyzed. Indication available:incorrect value, not aligned, not checked, piece of traffic was scrambled/descrambled, no indication (meaning correct value). These indication have to be explicitly set by the analyzer.

At the end of the tree, all the viewer information can be dumped in a file. The end of the tree is the node in the tree where the piece of traffic passes last. For generators, this is the top of the tree, for analyzers this is in the leaves of the tree. It's also possible to dump the information in the file at an intermediate level. This is used when the particular piece of traffic is overhead at a certain level and is not passed to the next analyzer.

The contents of the dumped file can be viewed with the viewer. The file created by the dump for the viewer contains all information to be able to display each frame generated or analyzed by the test bench system and to navigate between them, each frame, meaning not only the frame at the top of the tree, but also in intermediate levels. When a frame at an intermediate level is displayed, all information/traffic belonging to frames higher up in the hierarchy are hidden. Only the information/traffic for the selected level is shown. The user can navigate up and down through the hierarchical layers of data as in a file structure.

In addition extra indications a byte has can be displayed, e.g. using code such as a combination of color codes, underlining, strike through, bold font, adding a box, etc. For example, if a bit belongs to overhead in a frame it can be displayed in red, payload in blue. Traffic that is neither overhead, nor payload is displayed in green. Traffic that the test bench system has analyzed as being incorrect, may have a cross over the value.

The viewer optionally has the following functions:

Search for a specific type of traffic data (overhead, payload, errored traffic).

A built-in distance calculator to calculate the distance, in number of bytes, between two bytes.

The values of the bytes/bits at a specific level can be dumped to a text file.

When the test bench system is still running, the viewer can automatically update itself whenever the dumpfile changes.

Highlight (draw a box around every byte/bit) any level when viewing another level.

Set a marker on a byte. The location of the marker is remembered when browsing through the hierarchy.

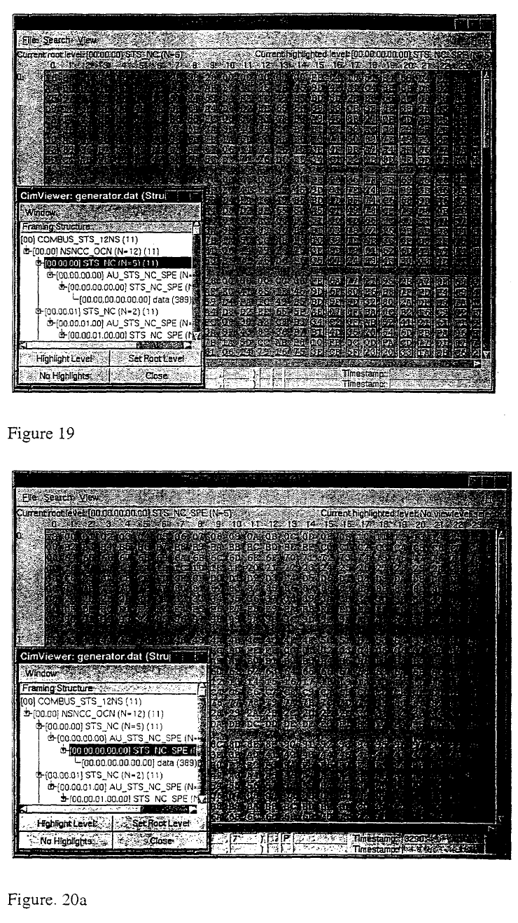

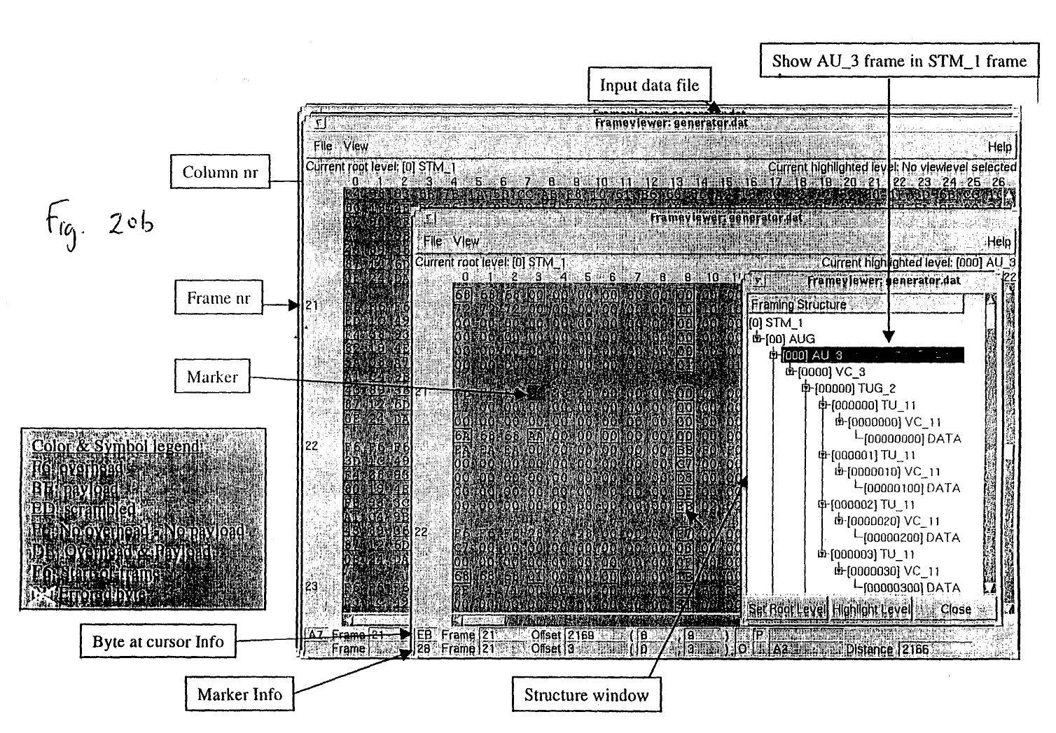

FIGS. 19 and 20 show some screenshots of the viewer. The screen of FIG. 20a is from the same dump file as FIG. 19 but at a lower level in the hierarchy. Actually, the level shown in the screenshot of FIG. 20a is the same level that is highlighted in the screenshot of FIG. 19. In operation a control element of the user graphic interface is selected, e.g. by using a pointing device such as a mouse or by keyboard input or similar. Selection of this control element sends a signal to the verification system program running on the computer to display the hierarchical structure of the data preferably in a new and separate structure window which can be tiled or cascaded with a window to display the data. The verification system program make use of the fact that the framed data was generated under its control when the data stream was generated. Therefore with knowledge of the protocols involved and the behavior of the simulated device, the verifications system program reconstructs the hierarchical tree structure of the analyzed data and displays it. This display is conveniently in the form of a tree structure in the structure window. By selecting a part of this tree, e.g. by mouse double clicking or pressing “enter” on the keyboard, a signal is sent to the verification program to collect and display the framed data associated with that part of the hierarchy. At the same time the displayed data is annotated with one or more of the codes given above, e.g. the start bit of a frame may be displayed with a recognizable code. In particular the framed data is displayed in columns and rows. An example, of the detail displayed by the user graphical interface in accordance with the present invention is shown in FIG. 20b, in which column number, frame number, a marker, byte reference at cursor position, marker information, input data file and the structure window can be determined.

FIG. 21 is a schematic representation of a computing system which can be utilized with the methods and in a system according to the present invention. A computer 41 is depicted which may include a video display terminal 14, a data input means such as a keyboard 16, and a graphic user interface indicating means such as a mouse 18 for use as a pointing device with the graphical user interface in accordance with the present invention. Computer 41 may be implemented as a general purpose computer, e.g. a UNIX workstation, a personal computer.

Computer 41 includes a Central Processing Unit (“CPU”) 15, such as a conventional microprocessor of which a Pentium III processor supplied by Intel Corp. USA is only an example, and a number of other units interconnected via system bus 22. The computer 41 includes at least one memory. Memory may include any of a variety of data storage devices known to the skilled person such as random-access memory (“RAM”), read-only memory (“ROM”), non-volatile read/write memory such as a hard disc as known to the skilled person. For example, computer 41 may further include random-access memory (“RAM”) 24, read-only memory (“ROM”) 26, as well as an optional display adapter 27 for connecting system bus 22 to an optional video display terminal 14, and an optional input/output (I/O) adapter 29 for connecting peripheral devices (e.g., disk and tape drives 23) to system bus 22. Video display terminal 14 can be the visual output of computer 10, which can be any suitable display device such as a CRT-based video display well-known in the art of computer hardware. However, with a portable or notebook-based computer, video display terminal 14 can be replaced with a LCD-based or a gas plasma-based flat-panel display. Computer 41 further includes user interface adapter 19 for connecting a keyboard 16, mouse 18, optional speaker 36. Data may be input to the computer 41 from an external telecommunications device 20 such as personal computer or work station via a network 40 such as the Internet. This allows transmission of descriptor files comprising a representation of a telecommunications device be simulated over a telecommunications network 40, e.g. entering a description of a physical system at a near location and transmitting it to a remote location, e.g. via the Internet, where a processor carries out a method in accordance with the present invention and returns a parameter relating to the physical system to a near location.

Computer 41 also includes a graphical user interface that resides within machine-readable media to direct the operation of computer 10. Any suitable machine-readable media may retain the graphical user interface, such as a random access memory (RAM) 24, a read-only memory (ROM) 26, a magnetic diskette, magnetic tape, or optical disk (the last three being located in disk and tape drives 23). Any suitable operating system and associated graphical user interface (e.g., Microsoft Windows) may direct CPU 15. In addition, computer 41 includes a control program 51 which resides within computer memory storage 52. Control program 51 contains instructions that when executed on CPU 15 carry out the operations described with respect to any of the methods of the present invention.

Those skilled in the art will appreciate that the hardware represented in FIG. 21 may vary for specific applications. For example, other peripheral devices such as optical disk media, audio adapters, or chip programming devices, such as PAL or EPROM programming devices well-known in the art of computer hardware, and the like may be utilized in addition to or in place of the hardware already described. In the example depicted in FIG. 21, the computer program product (i.e. control program 51) can reside in computer storage 52. However, it is important that those skilled in the art will appreciate that the mechanisms of the present invention are capable of being distributed as a program product in a variety of forms, and that the present invention applies equally regardless of the particular type of signal bearing media used to actually carry out the distribution. Examples of computer readable signal bearing media include: recordable type media such as floppy disks and CD ROMs and transmission type media such as digital and analogue communication links.

The present invention has been exemplified in a computer based verification system known as CimTester™. In the annex a tutorial relating to this product provides further explanation with respect to the system and to the use of the graphics interface described above and referred to in the tutorial under the name FrameViewer™.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. Computer apparatus for displaying and manipulating sequences of frames of hierarchically organized framed data, comprising:
means for generating a graphical user interface on a display screen, the graphical user interface having means for displaying a representation of a hierarchy of the framed data,
a pointing device for selecting a portion of the representation of the hierarchy to generate a control signal, and
means responsive to the control signal to display a portion of the framed data corresponding to the selected portion of the representation of the hierarchy.

2. Computer apparatus according to claim 1, further comprising for coding data as displayed on the display screen as one of overhead, payload, neither overhead nor payload and incorrect.

3. Computer apparatus according to claim 1, further comprising at least one of: means for searching for a specific type of traffic data type, a distance calculator to calculate the distance, in number of bytes, between two bytes of data˜means for dumping values of the bytes/bits at a specific level in the hierarchy, means for updating the display whenever a dump file changes, means for highlighting data on the display screen at any level when viewing another level, means for setting a marker on a byte of data, and means for maintaining the location of the marker when browsing through the hierarchy.

4. Computer apparatus according to claim 1, further comprising a frame generator for receiving a frame sequence, the frame generator comprising means for processing the frame sequence in accordance with a protocol to form a mod)fied frame sequence and for associating with each frame a description data structure for that frame, and
means for outputting the mod)fied frame sequence and the frame description data structure.

5. Computer apparatus according to claim 4, further comprising: a frame analyzer for receiving a sequence of frames and a description data structure, the frame analyzer comprising means for separating the sequence of frames from the description data structure.

6. Computer apparatus according to claim 5, further comprising:
a first frame scheduler for triggering reading of an input frame sequence of the frame generator.

7. Computer apparatus according to claim 6, further comprising:
a second frame scheduler for triggering reading of an input frame sequence of the frame analyzer.

8. Computer apparatus according to claim 7, further comprising:
test program execution means for executing a pre-defined test program on the framed data by interacting with the frame generator and the frame analyzer.

9. Computer apparatus according to claim 8, wherein the test program execution means interacts with the frame generator and the frame analyzer through a set of interaction objects.

10. Computer apparatus according to claim 5, wherein the framed data is input to the frame analyzer from a simulator or from a telecommunications device.

11. Computer apparatus according to claim 5, further comprising a plurality of frame generators and a plurality of frame analyzers, the pluralities being organized in a hierarchical tree structure.

12. A computer based verification system for the analysis and display of a sequence of frames of framed data, comprising:
means for generating a frame generator for receiving the frame sequence, the frame generator comprising means for processing the frame sequence in accordance with a protocol to form a mod)fied frame sequence and for associating with each frame a description data structure for that frame, and means for outputting the mod)fied frame sequence and the frame description data structure.

13. The system according to claim 12, further comprising:
means for generating a frame analyzer for receiving a sequence of frames and description data structures, the frame analyzer comprising means for separating the sequence of frames from the description data structures.

14. The system according to claim 13, further comprising:
a first frame scheduler for triggering reading of an input frame sequence of the frame generator.

15. The system according to claim 14, further comprising:
a second frame scheduler for triggering reading of an input frame sequence of the frame analyzer.

16. The system according to claim 15, further comprising:
test program execution means for executing a pre-defined test program on the framed data by interacting with the frame generator and the frame analyzer.

17. The system according to claim 16, wherein the test program execution means interacts with the frame generator and the frame analyzer through a set of interaction objects.

18. The system according to claim 13, wherein the framed data is input to the frame analyzer from a simulator or from a telecommunications device.

19. The system according to claim 13, further comprising a plurality of frame generators and a plurality of frame analyzers, the pluralities being organized in a hierarchical tree structure.

20. The system according to claim 19, wherein a communication means is provided between a generator and a next generator.

21. The system according to claim 12, further comprising: a graphical user interface for displaying the framed data annotated with at least part of the description data structure.

22. The system according to claim 17, further comprising: a graphical user interface for displaying the framed data annotated with at least part of the description data structure.

23. A method of analyzing and displaying a sequence of frames of framed data, comprising the steps of: generating a frame sequence in accordance with a protocol, associating with each frame a description data for that frame, and outputting the frame and the frame description data.

24. The method according to claim 23, further comprising the steps of:
receiving a sequence of frames and a description data structure and separating the sequence of frames from the description data structure.

25. The method according to claim 24, further comprising inputting the framed data from a simulator or from a telecommunications device.

26. The method according to claim 25, further comprising:
displaying the framed data annotated with at least part of the description data structure.

27. A method of analyzing framed data comprising the steps of:
entering a descriptor file at a near location such as a terminal connected to a telecommunications network, the descriptor file comprising at least a representation of the operation of a telecommunications device;
transmitting the descriptor file over the telecommunications network to a remote location;
generating framed data at the remote location using a computer based system in accordance with claim 1;
and receiving at a near location the modified framed data and description data associated with the frame data.

28. The method according to claim 27, further comprising storing the framed data and the description data at an intermediate node of the telecommunications.

29. A method of analyzing framed data comprising the steps of:
entering a descriptor file at a near location such as a terminal connected to a telecommunications network, the descriptor file comprising at least a representation of the operation of a telecommunications device;
transmitting the descriptor file over the telecommunications network to a remote location;
generating framed data at the remote location using a computer based system in accordance with claim 12;
and receiving at a near location the modified framed data and description data associated with the frame data.
